(19) United States
(12) Patent Application Publication
(10) Pub. No.: US 2006/0064326 A1
(43) Pub. Date: Mar. 23, 2006

(54) System and process for prescribing medications through the internet

(76) Inventor: Jeff Tucker, Conroe, TX (US)

Correspondence Address: D'AMBROSIO & ASSOCIATES, P.L.L.C., 10260 WESTHEIMER, SUITE 465, HOUSTON, TX, 77042, US

(21) Appl. No.: 11/148,102

(22) Filed: Jun. 8, 2005

Related U.S. Application Data
(63) Continuation-in-part of application No. 09/685,369, filed on Oct. 10, 2000, now abandoned.

(51) Int. Cl. G06F 19/00

(52) U.S. Cl. 705/3

(57) ABSTRACT

A centralized system and process for prescribing medications through the Internet comprising a secured, interactive website with a unique URL address for entering and retrieving medical prescriptions via the Internet by a general use computer. The website is secured by encryption and by limiting access to medical and pharmaceutical personnel having authorized I.D. A dedicated central remote server is accessed through the website with access limited to authorized users. The remote server comprises computer hardware capable of data storage for system data for the website. A high security Internet service provider connected to the remote server provides access to the website by authorized personnel. The process can create a patient file with patient identifying information, if necessary. The system further comprises means for entering patient prescription information into patient file, for retrieving patient prescription information from patient file and for entering data regarding filling of prescription in patient file.

### FIELD OF THE INVENTION

The present invention relates to a system and process for prescribing medications through the Internet. More particularly, the present invention relates to a system and process allowing access by authorized users to a dedicated central remote server via the Internet for entering and retrieving medical prescriptions.

### BACKGROUND OF THE INVENTION

The traditional method of prescribing medications for a patient by a physician is by a handwritten written prescription containing the drug therapy information which the patient must take to a pharmacy to be filled. Current computerized systems are available among chains of pharmacies so that any store within the chain has access to the prescription thereby allowing the patient to refill the prescription in any city where a member of the chain exists.

Computerized systems are also available for hospital computer systems that allow a doctor to enter information regarding a patient, including prescribing drugs, onto the hospital's computer. U.S. Pat. No. 5,758,095 to Albaum et al., teaches a system and method for ordering and prescribing drugs using interactive software on a hospital computer system networked with the hospital pharmacy. Means for accepting and processing the information regarding prescriptions includes an interpreter and reformatter means to process the information received in a random sequence. Security is not an issue since the patient information and data is contained within the hospital computer system or computer systems having the necessary software and networked to the hospital computer system. It is not accessible outside the system.

Websites are available to the public offering to fill prescriptions, Internet pharmacies for example. Online pharmacies require either a written prescription, authorized by the signature of a licensed physician, to be mailed or faxed to the pharmacy or telephone confirmation for any controlled medications before the prescriptions can be filled.

What is needed is a central, secure system and process that physicians can use to prescribe medications for patients so that the prescription can be filled anywhere that has access to the World Wide Web/Internet without a handwritten signature or oral confirmation.

Definitions:

1. Web Site: A set of interconnected webpages, usually including a homepage, generally located on the same server, and prepared and maintained as a collection of information by a person, group or organization.
2. Web Page: A document on the World Wide Web, consisting of an HTML file and any related files for scripts and graphics, and often hyperlinked to other documents on the Web.
3. Web Browser: A program that accesses and displays files and other data available on the Internet and other networks.
4. URL: An Internet address (for example, http://www.hmco.com/trade/), usually consisting of the access protocol (http), the domain name (www.hmco.com), and optionally the path to a file or resource residing on that server (trade).
5. Interactive: Of or relating to a program that responds to user activity.
6. Server: A computer that controls a central repository of data that can be downloaded or manipulated in some manner by a client.
7. Encryption: To alter (a file, for example) using a secret code so as to be unintelligible to unauthorized parties.
8. FTP: A communications protocol governing the transfer of files from one computer to another over a network.
9. ISP: Internet Service Provider
   All definitions taken from the online The American Heritage® Dictionary of the English Language: Fourth Edition, 2000.

### SUMMARY

The present invention provides a surprisingly straightforward system and process for prescribing medications through the World Wide Web via a secured Internet system. Preferably, the system comprises a secured, interactive website for entering and retrieving medical prescriptions, the website accessible via the Internet at a unique URL address by a general use computer. The preferred website is secured by encryption. The secured website can be further secured by limiting access to medical personnel having an authorized I.D. code and pharmaceutical personnel having an authorized I.D. code.

In one aspect, a single dedicated central remote server is connected to the Internet with access limited to users having the authorized codes. The remote server can comprise computer hardware capable of storage of all active data for the website. Preferably, a high security. Internet service provider is connected to the remote server for providing access to the website by authorized personnel. The preferred system further comprises means for creating a patient file with patient identifying information, means for entering patient prescription into the patient, means for entering data regarding filling of prescription in patient file and means for logging off patient file screen so as to secure patient information.

In one preferred embodiment, the website further comprises Internet links to one or more drug information databases comprising drug history, adverse reactions to drugs, interactions between two or more prescribed medications. Preferably, the website further comprises a database of patient medication history. In one aspect, the remote dedicated server and the Internet system provider are the same computer hardware system. Alternatively, the remote dedicated server and the Internet system provider comprise different computer hardware systems. Preferably, the means for creating a patient file comprises a screen for entering identifying information selected from a group comprising: patient name, patient social security number, patient driver's license, patient I.D. code or a combination thereof.

Preferably, the authorized I.D. is selected from a group comprising: driver's license number, social security number, a personal code or identification number. Alternatively, the authorized I.D. is selected from a biometric group comprising eye scan, thumb scan, hand scan or fingerprint scan or voice recognition. In one aspect, the website of this invention further comprises Internet links to health insurance providers.

An alternative embodiment of the invention comprises a process for prescribing medications through the World Wide Web via a secured Internet connection to a dedicated central remote server. Preferably the process comprises the following steps:
(a) providing a secure website for subscribers for entering and retrieving medical prescriptions stored on a dedicated central remote server;
(b) providing a URL address for accessing the website so that the website is accessed by a general use computer connected to the Internet;
(c) securing the website of step (a) by encryption and further securing the website of step (a) by limiting access to medical personnel having an authorized I.D. and pharmaceutical personnel having an authorized I.D.;
(d) storing all active patient in the dedicated central remote server, the patient data entered and retrieved via the website of step (a);
(e) accessing a patient file, if available;
(f) entering a prescription into patient file;
(g) retrieving the prescription entered into patient file by pharmacy personnel.

An alternative system of the present invention comprises a system for storing medical patient records on a secured website. Preferably, the system for storing medical patient records comprises the following:
(a) a secured, interactive website for entering and retrieving a patient's medical data, the website stored on a dedicated central remote server, the website accessible via the Internet by a general use computer;
(b) the website comprising a unique URL address for further accessibility via the Internet;
(c) the website of (a) secured by encryption, and further secured by limiting access to medical personnel having an authorized I.D.;
(d) the centralized, dedicated remote server is connected to the Internet with access limited to users having the authorized I.D. of (c),
(e) the dedicated remote server comprising computer hardware capable of storage of the patient data entered and retrieved via the website;
(f) a high security Internet service provider connected to the dedicated central remote server for providing access to website by personnel authorized according to (c);
(g) means for creating a patient file with patient identifying information;
(h) means for entering patient prescription into patient file created in (g);
(i) means for entering data regarding changes to patient file;
(j) means for logging off patient file screen so as to secure patient information.

Preferably, the website provided in (a) further comprises Internet links to one or more medical information databases comprising current therapy and medical treatment for medical diseases and disorders. The website provided in (a) can further comprise Internet links to one or more drug information databases comprising drug history, adverse reactions to drugs, interactions between two or more prescribed medications.

### BRIEF DESCRIPTION OF THE DRAWINGS

FIG. 1 is a flowchart of one embodiment of the process of the present invention.

FIG. 2 is a schematic of one embodiment of the system of the present invention.

FIG. 3 is a flowchart of an embodiment of the secured log-on steps of the present invention.

FIG. 4 is a flowchart of an embodiment of patient data input.

FIG. 5 is a flowchart of an embodiment of the physician log-on steps and data input.

FIG. 6 is a flowchart of an embodiment of pharmacy log-on and data input.

FIG. 7 is a flowchart of client registration according to one embodiment of the invention.

### DETAILED DESCRIPTION OF THE PREFERRED EMBODIMENT

The present invention is a system and process for prescribing medications through the Internet using a medical prescription service website that is accessible to licensed users for entering and retrieving medical prescriptions. The website is a set of interconnected web pages located on the central server accessible on the Internet by use of its URL address. Advantageously, the system and process is secure so that only authorized users, prescribing physicians and pharmacists, for example, with proper identification can enter the secured pages of the website. In this way, a physician can enter a prescription quickly and easily onto the secured website of the medical prescription service. The pharmacy selected by the patient can access the medical prescription service website, locate the patient's record, obtain the prescription and fill it within minutes of entry by the doctor. The prescription can be entered by any licensed physician anywhere in the world with access to the Internet, and filled by any pharmacy with access to the Internet. Patient information is secured though an encryption system thereby protecting patient privacy and medical information from access by the general public.

Referring now to the drawings, the details of the preferred embodiments of the present invention are schematically illustrated. All arrows represent bi-directional data flow, with dashed arrows representing secured data flow.

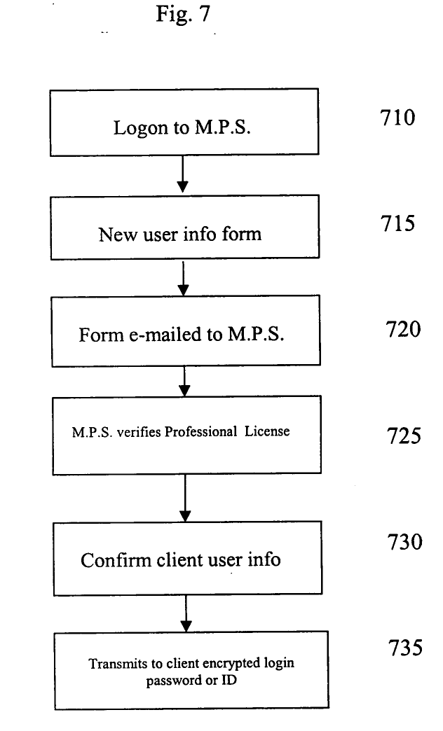

The users of the systems and processes of this invention are preferably limited to clients who are licensed physicians, their authorized personnel and licensed pharmacy personnel. Licensed physicians means physicians licensed by a state board to practice medicine. Preferably, clients are authorized to use the system and processes of this invention by registration as illustrated by FIG. 7.

A licensed physician or pharmacist contacts the medical prescription service via its web home page, which is accessible to the general public. Alternatively the medical prescription service can be contacted by e-mail, regular mail, facsimile or other means. Preferably, the potential client logs on to the website home page 710 using a unique URL address, and clicks onto a new user information form 715. The form is e-mailed to the medical prescription service 720. The medical prescription service verifies the professional license of the client 725 and confirms the client user information 730. The medical prescription service assigns the client an encrypted login password or code and securely transmits to the client the encrypted login password or code 735.

Alternative methods of securing the medical prescription service website include biometric coding. Biometric coding uses physical characteristics for identifying and authenticating a user. For example, retinal recognition, finger or handprints or voice recognition may be utilized to identify the client as an authorized user. The client's computer is adapted to scan the body part and transmit the information to the medical prescription service server to match the scan with a list of authorized clients. Other methods of identifying an authorized client to access the sensitive information on the medical prescription service website can be used to limit access.

Payment for the service by the client physician or pharmacist can be made through a secure financial transaction system using a credit card. Secured financial transaction systems are known in the art and readily adaptable for use with the system. Alternatively, direct banking or other methods of payment can be used.

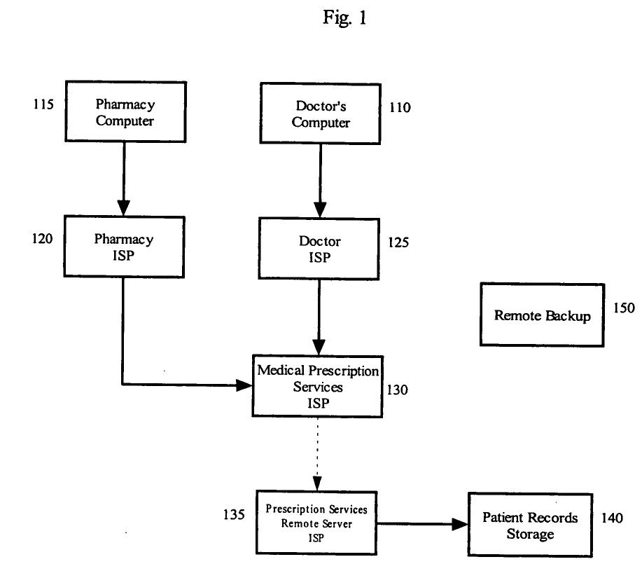

Once the client has a secured, encrypted login password, the client can gain access to the medical prescription service website as illustrated in FIG. 1. The website comprises a unique URL address. Referring to the schematic of FIG. 1, the client physician or pharmacy connects to the Internet by means of a general use computer 110, 115 via his or her own Internet Service Provider (ISP) 120, 125 and a web browser. The client can use any type of computer hardware that gives the client access to the ISP. New computer-type systems, not yet available, are within the scope of this invention if they enable access to the Internet. The website for the medical prescription service is located on one central remote server accessed by contacting its ISP address 130. A server is a computer that is connected to one or more other computers allowing the other computers access to a website and the data and programs stored on the website. The server computer is permanently connected to the Internet and is a centralized hub for other computer wishing access to the web site stored on the server. Although the server is accessed by a specific numerical ISP address, for ease of use, a single, unique URL address may also be in the form of a domain name, such www.medicalprescriptionservice.com, which when entered brings up the website for the client. The medical prescription service maintains the website at the address, the website consisting of a homepage and other connected web pages, such as web pages for identification of clients, entry of prescriptions and patient, drug or medical informational databases. The introductory and login page(s) for the website are stored on the server of the medical prescription service. Access to the homepage and login pages is available to the general public via the Internet. Patient information, medical information databases, drug information databases and any other medically related database or sensitive data stored on the remote server is maintained by the medical prescription service.

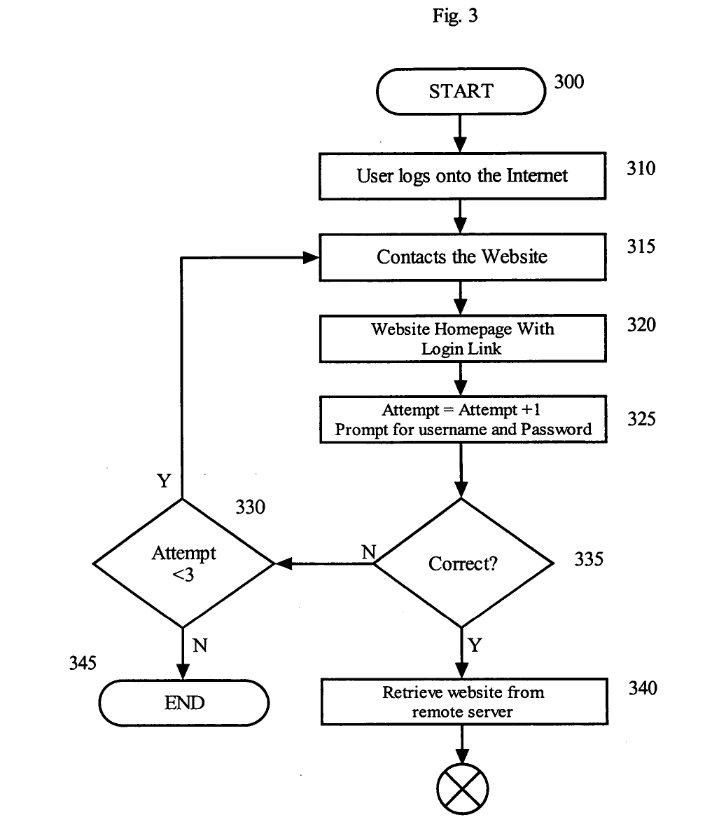

As shown in FIG. 3, access to the remote server is only available to clients with a secured, encrypted pass code or other means of identification, such as a biometrics, for example. The client, using their computer 300, logs on to the Internet 310 and contacts the website 315. The website homepage with the logon screen is shown 320. The client enters the proper information 325, and if correct 335, gains access to the remote server 340. If the information entered is incorrect 330, access is denied and the procedure terminates 345. Absolutely no access to the remote server is permitted until after the visitor to the medical prescription service homepage correctly enters all of the necessary security information. This information would typically consist of a subscriber ID number, username and secured, encrypted password, code or biometrics.

Upon verification of the login information, a log of the client's admittance into the system is created and the client is presented with a list of options, such as updating an existing patients' record, viewing a patient record, etc.

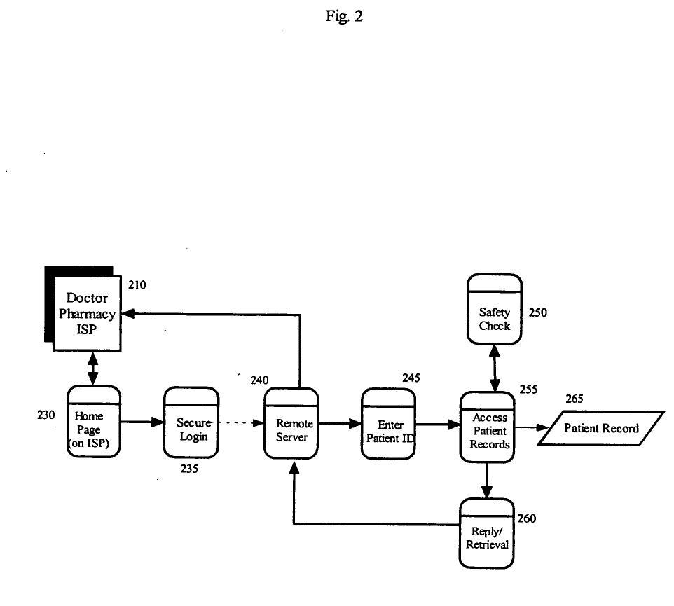

As shown in FIG. 2, patient records can be stored on a highly secure and recoverable storage system. FIG. 2 is a representation of the process, showing an external entity represented by a double shaded box, with the process steps represented by rounded boxes and a trapezoid for representing data storage. The doctor/pharmacy 210 accesses the home page 230 and securely logs on 235 to the remote server 240. The patient ID is entered 245 and patient records are accessed 255. Connected to the patient record access is a backup system, such as a fail-safe system or safety check 250 that activates when the primary system fails ensuring that there is no interruption of service. Other backup systems can also be used such as a RAID (Redundant Array of Inexpensive Disks), which is also backed up daily to a remote backup 150 external medium such as tape, removable disk or recordable CD. Should disaster strike and one or more of the drives in the array fail, the data can be restored via the other drives in the array or from the backup media. In case of catastrophe, such as fire, flood, or other non-recoverable destruction of patient records, a reasonably current copy of all data can be stored at a Remote/Off-site backup location 150.

A secure Internet information server is required for the medical prescription service of this invention. Preferably, the server can support a high bandwidth connection to the Internet, encryption and support for redundant and highly secure storage devices such as RAID (Redundant Array of Inexpensive Disks) controllers and removable media backups. Hardware and operating system software may vary. Encryption as use in reference to this invention is any procedure that converts data into a form that prevents anyone but the intended recipient from reading the encrypted data. Both Netscape's® Navigator™ and Microsoft's® Internet Explorer™ have encryption built in and automatically use it whenever transmitting data over a secure network. Preferably, other secure encryption programs can be used to ensure that access to the medical prescription service website, other than the homepage, is limited to authorized clients. Alternatively, host Internet server systems are available that can provide a secured website. One such fully functional Internet server system is marketed under the trademark, VSERVER™.

High capacity storage and backup both on and off site are preferred. For primary storage, a ratio of less than one megabyte of storage per patient, physician and pharmacy can be used for storing patient prescription, physician and pharmacy identification information. Alternatively, the storage space can be increased or decreased depending on the amount of data regarding each patient that is desired. In one embodiment, about 10 to 20 gigabytes of additional storage are preferred for the system software and operating system. Again, the amount of storage space is dependent on the amount of data and databases the medical prescription service desires to be available to clients. Alternative embodiments of this invention can include a system and process of storing a patient's entire medical history as well as pharmaceutical information. These embodiments require additional storage space.

In one aspect of this invention, the Internet service provider can also store the encrypted patient information and drug prescription information. The preferred Internet service provider comprises a secure server that allows a remote server to be connected to its network. Storing the sensitive patient information and drug prescriptions on a remote server operated by the medical prescription service is an additional security precaution. Preferably, sensitive patient information is not stored by a third party server. The data is not stored on a system shared by unauthorized users, thereby vulnerable to hacking or other abuse. Control over backups and the integrity of patient information is paramount to the successful operation of this invention.

In an alternative system, security can be maintained through the use of “Digital Certificates”, electronic files that act like an online passport. They are issued by a trusted third party, a certificate authority (CA), which verifies the identity of the certificate's holder. They are tamper-proof and cannot be forged. Both Netscape's® Navigator™ and Microsoft's® Internet Explorer™ (versions 3 and above respectively) support Digital Certificate. Access is available via “http://home.netscape.com/security/techbriefs/index.html”. An ODBC (Open Database Connectivity) compliant database in which to store patient records is also preferred. ODBC databases are accessible over a network and capable of being manipulated using Structured Query Language (SQL). SQL server software can be installed on the remote server to access and modify the patient database.

In one embodiment of the present invention, the user/client accesses the website via the Internet. The homepage for the website can reside on the medical prescription service's server ISP (Internet Service Provider) and consists of an introductory splash screen along with links to information about the site and its services, contact information, and membership application, as well as a link for accessing patient information. At this level, all website information resides on the ISP. Absolutely no access to the remote server containing crucial and sensitive patient information or databases is permitted until after the visitor passes all necessary security.

Preferably, the user enters an ID, biometric scan, username or password before gaining access to the remote server. Upon verification, the ISP connects to a remote server using an encrypted and secure link. “Encryption” refers to the encoding of information transmitted over the Internet to prevent it from being read by anyone without the proper authorization. Encryption is built in to the most popular web browsers in use today (Microsoft's® Internet Explorer™ and Netscape's® Navigator™/Communicator Suite™) and is performed automatically. “Encryption challenged” web browsers will not be permitted to enter the system.

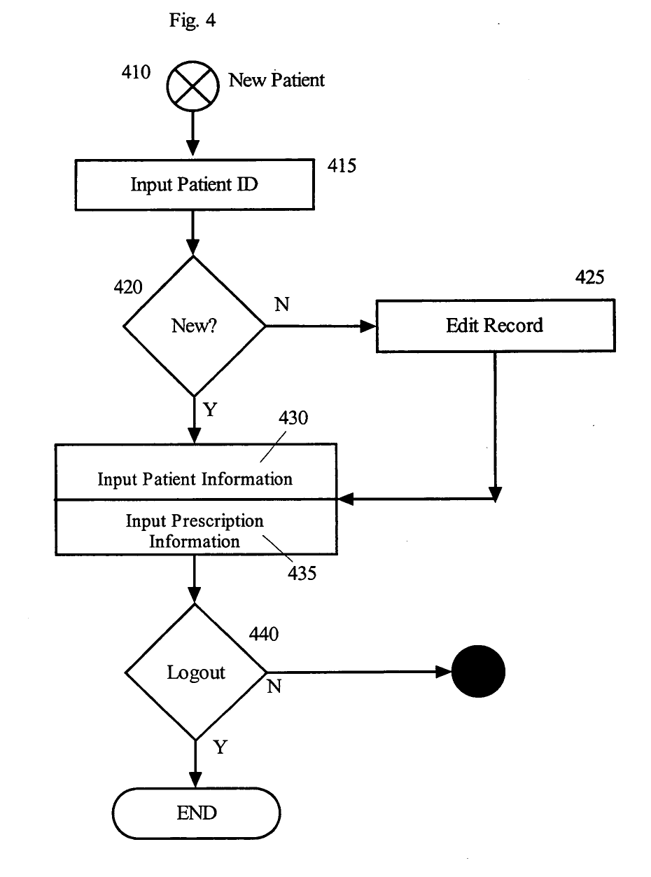

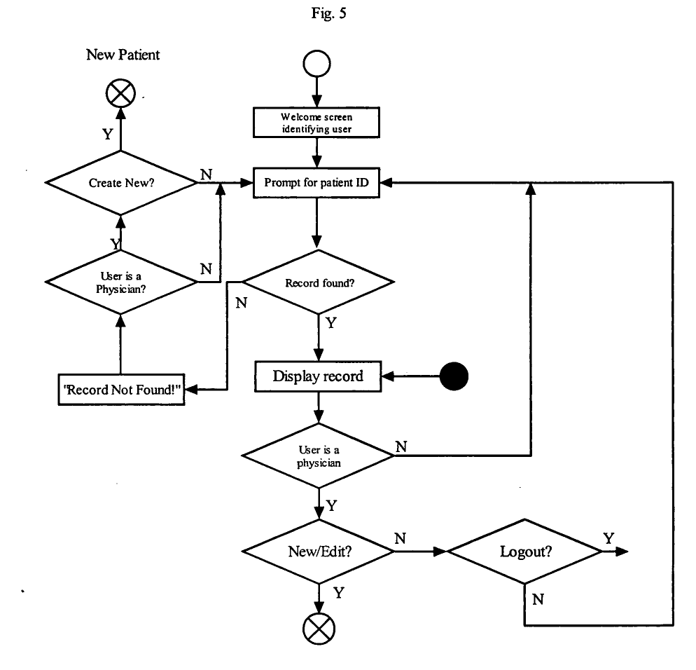

The remote server then acknowledges or identifies the client by name and presents the client with a menu of available options. The client enters the identifying information of the patient whose records they wish to access. This can comprise the patient's name, ID number, social security number, driver's license number, phone number, or any combination thereof. The system then retrieves the patient's record and displays any pertinent information and/or a menu of options. Alternatively, the doctor/client can create a patient record file with patient identifying information as illustrated in FIGS. 4 and 5. To create a record for new patient 410, an input patient ID is entered 415. At a prompt for whether a patient is new 420 yes is entered and input patient information 430 and/or input patient prescription information 435 is entered. The client then logs out 440, ending the session. If the patient is already in the database, the patient's records may be edited 425.

Patient records are then accessed and displayed for the client. If changes or updates are made to the patients record, such as the addition of a new prescription, the system then can check the new medication against the list of other drugs and therapies the patient may be under. This check searches for dangerous drug interactions or any activities that should not be followed while using said medication. Only doctors with the proper authorization code are allowed to make changes to a patient record.

After the doctor enters the prescription, the doctor can request another patient record or log off. If the doctor/client fails to log off, automatic log off occurs within a specific period of time. The patient, patient's representative or doctor can then contact a client pharmacy to have the prescription filled.

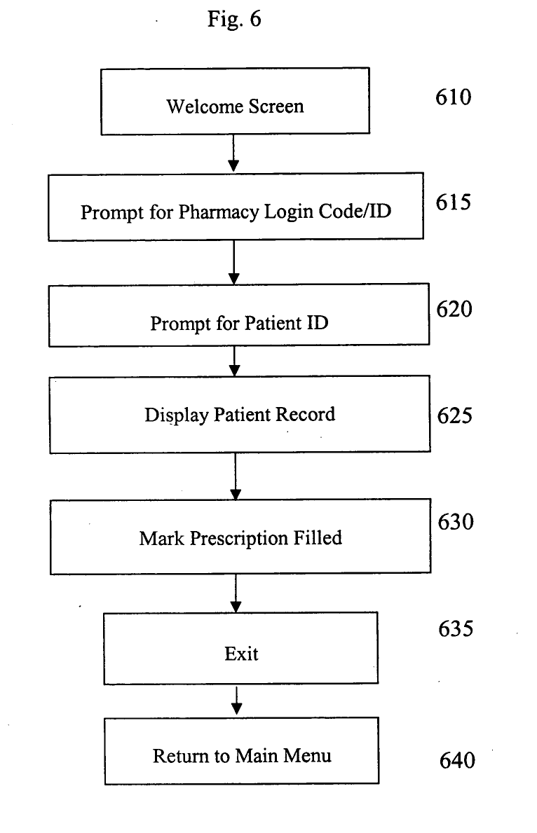

The client pharmacy, registered according to the flowchart of FIG. 7, connects to the Internet by means of a computer and its ISP. As depicted in FIG. 6, it accesses the medical prescription service's home web page 610, enters its I.D., pass code or biometric scan 615 and is connected to the patient record 620. The pharmacy can download the prescription or make a hard copy so that prescription can be filled 625. The client pharmacy then records that the prescription is filled 630 and logs off from that patient's records 635, returning to the main menu 640. At this point, the pharmacy can make further requests. The system then reports back to the client the results of their request regarding databases or links available on the medical prescription service website. From there, the pharmacy/client can either modify their request, access another patient record or logoff. Automatic log off occurs within a specific period of time, for example, fifteen minutes.

At such time that patient data no longer needs to be actively accessed, i.e. the patient becomes deceased or transfers to a different physician for healthcare services, the files may be transferred to different computer system for storage and removed from the medical prescription system server.

The foregoing description is illustrative and explanatory of preferred embodiments of the invention, and variations in the size, shape, materials and other details will become apparent to those skilled in the art. It is intended that all such variations and modifications which fall within the scope or spirit of the appended claims be embraced thereby. Although described in terms of the preferred embodiments shown in the figures, those skilled in the art who have the benefit of this disclosure will recognize that changes can be made to the individual steps which do not change the manner in which the system and process achieve their intended result. All such changes are intended to fall within the scope of the following non-limiting claims.

1. A centralized system for prescribing medications through the Internet comprising:
(a) an interactive website for entering and retrieving medical prescriptions, the website stored on one central, dedicated remote server for storing files and data required for prescribing medications, the dedicated remote server connected to the Internet;
(b) the website of step (a) comprising a unique URL address that is accessible via the internet by a general use computer;
(c) the website of step (a) secured by encryption, and further secured by limiting access to medical personnel having an authorized I.D. code and pharmaceutical personnel having an authorized I.D. code;
(d) the dedicated remote server comprising computer hardware and storage for active patient data in one location, the patient data entered and retrieved via the website of step (a);
(e) means for creating a patient file with patient identifying information;
(f) means for entering patient prescription information into the patient file;
(g) means for retrieving patient prescription information from the patient file; and
(h) means for entering data regarding filling of the prescription in the patient file.

2. The system of claim 1 wherein the website provided in step (a) further comprises internet links to one or more drug information databases comprising drug history, adverse reactions to drugs, interactions between two or more prescribed medications.

3. The system of claim 1 wherein the website further comprises a database of patient medication history.

4. The system of claim 1 wherein the website further comprises means for logging off patient file screen so as to secure patient information.

5. The system of claim 1 wherein the means for creating a patient file comprises a screen for entering identifying information selected from a group comprising: patient name, patient social security number, patient driver's license, patient I.D. code or a combination thereof.

6. The system of claim 1, wherein the authorized I.D. is selected from a group comprising: driver's license number, social security number, a personal code or identification number.

7. The system of claim 1 wherein the authorized I.D. is selected from a group comprising eye scan, thumb scan, hand scan, fingerprint scan or voice recognition.

8. The system of claim 1 wherein the website in (a) further comprises Internet links to health insurance providers.

9. A process for prescribing medications through the Internet comprising:
(a) providing a secure website for subscribers for entering and retrieving medical prescriptions stored on one dedicated remote server;
(b) providing a unique URL address for accessing the website so that the website is accessed by a general use computer connected to the Internet;
(c) securing the website of step (a) by encryption and further securing the website of step (a) by limiting access to medical personnel having an authorized I.D. and pharmaceutical personnel having authorized I.D.;
(d) storing active patient data in the dedicated remote server, the patient data entered and retrieved via the website of step (a);
(e) accessing a patient file, if available;
(f) entering a prescription into patient file; and
(g) retrieving the prescription entered into patient file by pharmacy personnel.

10. The process of claim 10 further comprising the step of creating a patient file, if not available according to step (f), the patient file comprising patient identifying information, the identifying information selected from a group comprising: patient name, patient social security number, patient driver's license, patient I.D. code or a combination thereof.

11. The process of claim 10 further comprising the step of logging off patient file screen to secure patient information.

12. A centralized system for storing medical patient records on a secured website comprising:
(a) a secured, interactive website for entering and retrieving a patient's medical data, the website stored on a dedicated central remote server, the website accessible via the internet by a general use computer;
(b) the website comprising a unique URL address for accessibility via the internet;
(c) the website secured by encryption, and further secured by limiting access to medical personnel having an authorized I.D. code;
(d) the dedicated central remote server connected to the internet with access limited to users having the authorized codes of (c);
(e) the dedicated central remote server comprising computer hardware capable of storage of the patient data entered and retrieved via the website;
(f) a high security Internet service provider connected to the dedicated central remote server for providing access to website by personnel authorized according to (c);
(g) means for creating a patient file with patient identifying information;
(h) means for entering patient prescription into patient file created in (f);
(i) means for entering data regarding changes to patient file;
(j) means for logging off patient file screen so as to secure patient information.

13. The system of claim 12 wherein the website provided in (a) further comprises Internet links to one or more medical information databases comprising current therapy and medical treatment for medical diseases and disorders.

12. The system of claim 12 wherein the website provided in (a) further comprises Internet links to one or more drug information databases comprising drug history, adverse reactions to drugs, interactions between two or more prescribed medications.
